(19) United States
(12) Patent Application Publication
(10) Pub. No.: US 2007/0212667 A1
(43) Pub. Date: Sep. 13, 2007

(54) Systems and methods for preparing dental restorations

(76) Inventors: Wayne D. Jung, Morton Grove, IL (US); Russell W. Jung, Morton Grove, IL (US); Walter W. Sloan, Lake Bluff, IL (US); Alan R. Loudermilk, Chicago, IL (US); Howard M. Tanner, Naperville, IL (US)

Correspondence Address: ALAN R. LOUDERMILK;LOUDERMILK & ASSOCIATES, PO BOX 3607, LOS ALTOS, CA, 94024, US

(21) Appl. No.: 11/374,446

(22) Filed: Mar. 13, 2006

(51) Int. Cl. A61C 5/10

(52) U.S. Cl. 433/223

(57) ABSTRACT

Improved systems and methods for producing dental restorations and ceramic materials for such restorations are disclosed. Optical properties, preferably including color and translucence characteristics, of a tooth or teeth of a patient are measured with a shade measuring instrument. The tooth to be restored is prepared, and a physical or virtual dental impression is created. A prescription for the restoration, which typically includes color, translucence and thickness information, is sent to the restoration fabrication facility either electronically or physically. A recipe and/or a mixture of ceramics are generated for the restoration, with multiple layers being specified, based on the measured optical properties. The recipe algorithm may adapt, or process checks may be performed, based on measurements of fabricated layers. Preferably, dental ceramics are specified to bracket the region of color space relevant to human teeth, and a reduced set of ceramic materials are manufactured and distributed. Based on measured optical characteristics of the ceramic materials, recipes and/or material mixtures are specified or prepared for the restoration. A virtual impression data file may be transmitted to the laboratory instead of a physical impression.

### FIELD OF THE INVENTION

The present invention relates to devices and methods for measuring optical characteristics such as color spectrums, translucence, gloss, and other characteristics of objects such as teeth, and more particularly to devices and methods for measuring the color and other optical characteristics of teeth or other translucent objects and for preparing restorations or other objects particularly in the field of dentistry, and also for manufacturing, distributing and utilizing ceramic materials for such restorations.

### BACKGROUND OF THE INVENTION

A need has been recognized for devices and methods of measuring the color or other optical characteristics of teeth and other objects, and for preparing restorations based on such measured optical characteristics particularly in the field of dentistry. Reference is made to the following applications, all by inventors hereof, which are hereby incorporated by reference, which disclose various systems and methods for measuring teeth and other objects and related systems, methods and technologies: U.S. application Ser. No. 09/091,208, filed on Jun. 8, 1998, which is based on International Application No. PCT/US97/00126, filed on Jan. 2, 1997, which is a continuation in part of U.S. application Ser. No. 08/581,851, now U.S. Pat. No. 5,745,229, issued Apr. 28, 1998, for Apparatus and Method for Measuring Optical Characteristics of an Object; U.S. application Ser. No. 09/091,170, filed on Jun. 8, 1998, which is based on International Application No. PCT/US97/00129, filed on Jan. 2, 1997, which is a continuation in part of U.S. application Ser. No. 08/582,054, now U.S. Pat. No. 5,759,030 issued Jun. 2, 1998, for Apparatus and Method for Measuring Optical Characteristics of Teeth; PCT Application No. PCT/US98/13764, filed on Jun. 30, 1998, which is a continuation in part of U.S. application Ser. No. 08/886,223, filed on Jul. 1, 1997, for Apparatus and Method for Measuring Optical Characteristics of an Object; PCT Application No. PCT/US98/13765, filed on Jun. 30, 1998, which is a continuation in part of U.S. application Ser. No. 08/886,564, filed on Jun. 30, 1998, for Apparatus and Method for Measuring Optical Characteristics of Teeth; and U.S. application Ser. No. 08/886,566, filed on Jul. 1, 1997, for Method and Apparatus for Detecting and Preventing Counterfeiting. Reference is also made to PCT App. Ser. No. PCT/US03/05310 filed on 21 Feb. 2003, which is a continuation in part of U.S. application Ser. No. 10/081,879, filed on 21 Feb. 2002, both of which are also hereby incorporated by reference. The foregoing patent documents are sometimes referenced collectively herein as the “Referenced Patent Documents.”

Dental restorations typically are provided in several forms. One method is to restore a portion of a tooth with a dental restorative material such as a composite. The dentist typically applies the composite directly to the tooth and then hardens the material with light or other radiant energy from a curing light or device. Another method is to take a dental impression of the tooth and build a precious metal-based restoration which is cemented to the tooth.

Another method is to replace an entire tooth with a pre-fabricated denture. Yet another method is to replace a portion of a tooth or replace the entire tooth with a ceramic restoration that is fabricated to match the adjacent teeth of the patient.

In most cases it is desirable to match the color of the restoration to the neighboring tooth or teeth. In the case of pre-manufactured restorations such as denture teeth, the dentist or dental technician desirably chooses a denture tooth which not only matches the size but also best matches the color of adjacent teeth. This traditionally has been achieved by ‘shade matching’ the tooth with a dental shade guide. This is a process whereby the dentist typically holds up pre-fabricated shade guides samples of different shades (each typically designated by one or more alpha-numeric symbols) and visually determines the closest match or matches. Manufacturers of denture teeth typically key the color of the denture teeth to visual shade guides such as the Vita Classical or Vita 3D Master® (3D Master is a trademark of Vita Zahnfabrik) shade guide systems.

Custom dental restorations such as porcelain fused to metal (PFM) or all ceramic restorations typically are produced by dental technicians in a facility often returned to a laboratory. The dentist typically makes a physical impression of the tooth and from the impression a three dimensional model is poured from a material such as plaster. The dentist also typically determines the best color of the restoration by comparing one or more neighboring teeth to a dental shade guide, or the dentist measures the color of the neighboring teeth with a spectrophotometer such as the Vita Easyshade® (Easyshade is a trademark of Vita Zahnfabrik), which electronically determines the best shade from one or more shade systems. Instrument-based shadematching systems and methods are described in the Referenced Patent Documents, and others are also available or under development.

The technician then typically fabricates the crown from ceramic materials provided by dental ceramic manufacturers. The ceramic materials are added, in several layers, to a coping which serves to strengthen the crown and provides a substructure to hold the unfired ceramic powders. Copings are generally 0.2-0.3 mm in thickness and are made from metal or ceramic (examples include, but are not limited to spinell, alumina, and zirconia, with tradenames of In Ceram®, Lava®, and Cercon®). With PFM restorations, one exemplary process is as follows. First a thin (e.g., 0.2 mm) opaque layer of ceramic typically is placed to cover the metal coping of the crown. The opaque layer increases the value and chroma of the metal and serves to fuse the ceramic materials to the metal substructure. The second layer is typically a semi-translucent ‘dentin’ layer and serves to simulate the natural dentin in a tooth. Finally, a third layer is applied which serves to simulate the enamel of a tooth. All three layers are designed to cause the restoration to best simulate the natural appearance of a tooth. In some cases, additional effect ceramics are added to the dentin and enamel layers to increase the translucency, opalescence, pearlesence and to add “maverick” colors or special characteristics to the ceramic restoration.

The final color of the restoration generally is determined by the colors of all the ceramic layers. Since the dentin and enamel layers are semi-translucent, their color is also influenced by their thickness. In general, the dentin layer is more chromatic and higher value than the enamel layer and the dentin layer largely serves to determine the hue of the final restoration. The enamel layer increases the visual perception of translucency of the final restoration. Increasing the enamel layer thickness tends to decrease the chromacity and value of the final restoration. Many dental ceramic materials assume that the overall thickness of the restoration will be in the range of 0.5 mm to 1.5 mm. Preparing a restoration outside of that thickness range tends to result in colors that vary from the ceramic recipe.

The color of the restoration traditionally is controlled by utilizing many dental ceramics. Typically these are provided in small bottles in dry powdered form, one or two bottles per shade color for the dentin layer, and additional bottles for the opaque and enamel layers; For example, Vita has many ceramic material systems, each with various physical properties, i.e., VMK 95, Omega, Omega 900, Alpha, VM7, VM9, and VM13. Each of these systems utilizes either one or two ceramic dentin layers. A two layer ceramic buildup system has an opaque layer, dentin layer and enamel layer. A three layer ceramic buildup system has an opaque layer, opaceous dentin (also known as opaque dentin) layer, dentin layer and an enamel layer. With both of these buildup systems, the opaque layer typically is not counted when those in the art refer to the number of layers. The Omega 900 ceramic system is a three layer buildup system and is keyed to the Vita 3D shade system, which has 29 basic shades and 81 interpolated shades. This system has 29 opaque shade bottles, 29 opaceous dentin shade bottles, 29 dentin shade bottles and several enamel shade bottles, totaling approximately 90 bottles.

For a dental technician to construct a Vita 3D interpolated shade of 3.5M2 with the Omega 900 ceramic material system, the mixing process (by hand) typically is as follows. The dental technician first dispenses the 3M2 and 4M2 opaque ceramics from their respective bottles in equal portions, mixes the powders on a glass slab, creates a ceramic slurry with the addition of modeling liquid, applies the mixture to the metal coping, and then fires the opaque layer. This process of dispensing the ceramic powders from the 3M2 and 4M2 bottles in equal portions, mixing the dry powders on a glass slab, adding modeling liquid to create a ceramic slurry is repeated for the opaceous dentin and dentin layers. The enamel layer is dispensed from, for example, the EN4 bottle, mixed with modeling liquid and applied over the dentin layer. Some dental technicians will fire the restoration between successive ceramic layers, others will fire after all the layers are added. The foregoing discussion is for representative purposes only, and specific ceramic bottle labeling, mixing and application of the ceramic materials will vary between ceramic systems and dental technicians.

Thus, as previously discussed, a dental technician must maintain many bottles of dental ceramics to best match the shade of a dental prescription. Additionally, dental ceramic manufacturers must provide the different ceramic shades and must have the resources to ensure quality control for all shades and for all materials. This is difficult to achieve, and batch to batch variations of ceramic materials tend to result in color variations of restorations produced using such materials. Vita, as an example, offers two shade systems the Classical and 3D Master systems. The Classical system has 16 shades, and the 3D Master system has 29 basic shades. Thus, it is easy for a dental manufacturer to be required to produce hundreds of different ceramics and each ceramic must be color controlled to exacting standards, which tends to be an extremely difficult and expense task.

The Vita 3D Master system is intended to permit a dentist to interpolate dental shades. Often, a tooth will not match a single shade but will appear to have a color between two shades. With the Vita 3D Master system, a dentist may more readily choose a color between two shades, expanding the number of colors available for the restoration. Advanced shadematching or shade measuring, preferably spectrophotometer-based instruments such as the Vita Easyshade system, also may select the best interpolated 3D Master shade. (Herein, as will be understood, systems and methods in accordance with the present invention preferably use the Vita Easyshade system, but optionally may use other suitable systems.)

If a dental technician is using the Vita Classical system (which historically has been the most widely utilized dental shade guide system), shade matching can be more difficult because the shades within the Classical system are not evenly distributed in color space. Certain regions of color space have numerous shades, while others have very few. Thus, if a patient has a shade in a region of color space that is not covered by a dental ceramic, a quality color match becomes difficult. This is also a difficulty with the 3D Master system, which does not have materials for low chromacity and low value (grayish) teeth.

Additionally, teeth have varying degrees of translucency which are not part of traditional shade guides. Although there are specialized shade guides for comparing the translucency of teeth, they are difficult to use and are rarely a portion of a dental prescription.

Although the systems described in the Referenced Patent Documents provide a variety of techniques for dental shade matching instruments and improvements in prostheses preparation based on the use of such instruments, there is still a need for improved systems and methods for preparing dental prosthetics.

### SUMMARY OF THE INVENTION

The present invention provides new and improved methods for producing dental restorations. In accordance with the present invention, optical properties, preferably including color and translucence characteristics, of a tooth or teeth of a patient are measured with a shade measuring instrument. An image of the tooth or teeth also may be taken such as with a digital camera. The tooth to be restored is prepared by the dentist. A physical or virtual dental impression is created, and a prescription for the restoration is sent to the laboratory. Thickness information also is conveyed to the laboratory, preferably by way of the dental impression. The transmission to the laboratory may include electronic and/or physical delivery, with physical delivery being required if the dentist creates a physical impression. Either with the shade measuring instrument or with computing device coupled to or receiving data from the shade measuring instrument, or alternatively with a ceramic mixing system, a recipe and/or a mixture of ceramics are generated for the restoration, with multiple layers being specified. In certain embodiments, the recipe and/or materials (including thickness) are specified for all of the layers of the restoration, or alternatively only the recipe and/or materials for the first layer or layers are provided. In such alternative embodiments, the dental technician at the laboratory may measure previous layers, and the recipe and/or materials for a subsequent layer or layers is provided based on the target optical characteristics and the optical characteristics of previously measured layers. The selection and mixture of ceramic materials preferably are based on measured optical characteristics of layers made with the ceramic materials that are available for selection.

In certain embodiments, the recipe algorithm adapts as color and translucence data are generated based on measuring layers made in accordance with previously specified recipes and/or materials. Optionally, process checks on the system also may be made based on such measurement data.

In accordance with other preferred embodiments of the present invention, dental ceramics are specified to bracket the region of color space relevant to human teeth, and a reduced set of ceramic materials are manufactured and distributed. Based on measured optical characteristics of the ceramic materials, recipes and/or material mixtures are specified or prepared for the restoration.

Also in accordance with the present invention, a virtual impression may be generated such as with a 3-D imaging device, with a virtual impression data file being transmitted to the laboratory instead of a physical impression.

In accordance with the present invention, dental restoration systems and methods are provided that may match the optical properties of a tooth including color, translucency, pearlescence, opalescence, and gloss. Such optical properties may be measured, for example, based on systems and methods described in the Referenced Patent Documents.

Accordingly, it is an object of the present invention to provide is a dental restoration systems and methods that cover the region of color space relevant to dental objects such as human teeth.

It is another object of the present invention to provide dental restoration systems and methods that require a minimal number of dental materials to cover the region of color space relevant to dental objects such as human teeth.

It is yet another object of the present invention to provide dental restoration systems and methods that permit matching color without reference to historic dental shade guide-based matching systems.

It further is an object of the present invention to provide dental restoration systems and methods that take into consideration the thickness of the restoration materials.

It also is an object of the present invention to provide methods of manufacturing and distributing dental ceramics with a reduced set of materials that bracket the region of color space relevant to dental objects such as human teeth so that restorations may be made that match human teeth with a reduced number of ceramic materials.

Finally, it is an object of the present invention to provide methods and systems for producing restorations that use a virtual impression that is electronically transmitted to a laboratory or other facility for fabricating restorations rather than delivering a physical impression.

### BRIEF DESCRIPTION OF THE DRAWINGS

The above objects and other advantages of the present invention will become more apparent by describing in detail the preferred embodiments of the present invention with reference to the attached drawings in which:

FIGS. 1A and 1B are exemplary process flow diagrams illustrating steps generally performed by dentists and dental technicians in accordance with certain preferred embodiments of the present invention;

FIG. 2 is a block diagram illustrating an exemplary ceramic mixing and dispensing system in accordance with certain preferred embodiments of the present invention;

FIG. 3 is an exemplary process flow diagram illustrating additional detailed steps in accordance with certain alternative preferred embodiments of the present invention;

FIG. 4 is an exemplary process flow diagram illustrating methods of manufacturing and distributing ceramic materials in accordance with certain preferred embodiments of the present invention;

FIG. 5 is an exemplary process flow diagram illustrating methods of producing restorations using a virtual impression that may be electronically transmitted; and

FIG. 6 is an exemplary process flow diagram illustrating methods of producing restorations including an electronic assessment of the dentist's tooth preparation.

### DETAILED DESCRIPTION OF THE PREFERRED EMBODIMENTS

The present invention will be described in greater detail with reference to certain preferred and alternative embodiments. As described below, refinements and substitutions of the various embodiments are possible based on the principles and teachings herein.

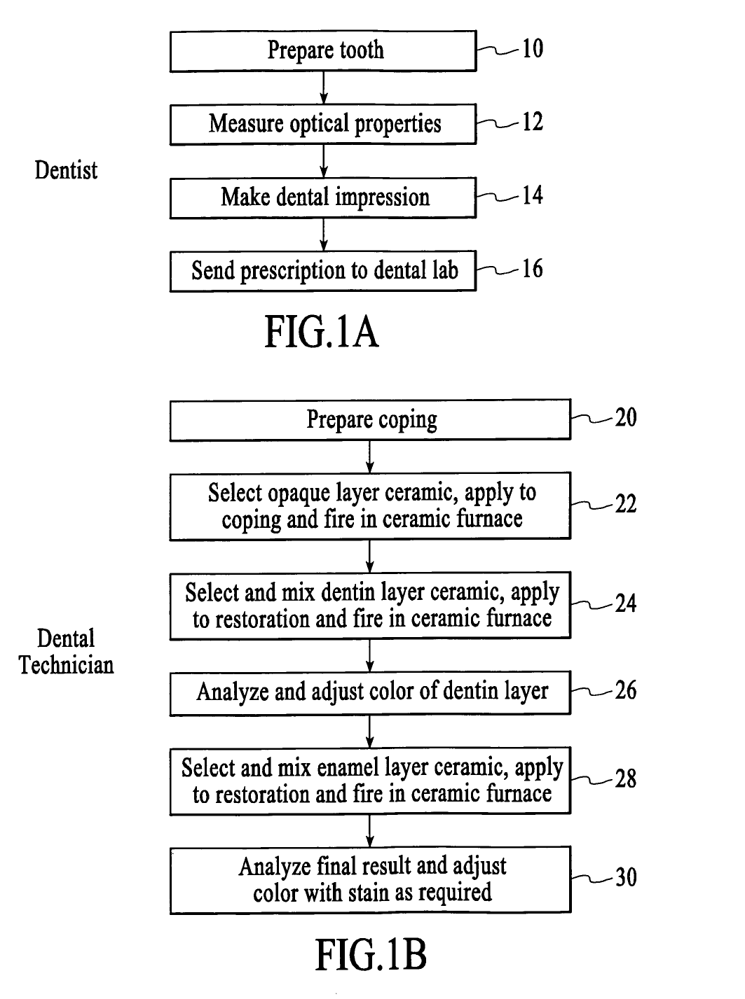

In accordance with the present invention, dental restorations may be generated in a more efficient and desirable manner. Referring now to FIG. 1, certain exemplary preferred embodiments will be described.

In accordance with first preferred embodiments of the present invention, a dental restoration is produced as follows. In step 10, the tooth is prepared by the dentist in a normal fashion. As is known in the art, this generally includes preparing the tooth so that a dental restoration may be attached to the tooth or otherwise installed in the mouth. Often the tooth preparation results in a post-like structure to which a restoration is attached. In step 12, the optical properties of the neighboring teeth are measured and recorded with a shade measuring instrument such as the Vita Easyshade. Optionally, a color photograph of the dental arch is taken, which may be combined with shade, color and/or translucence (and optionally other optical properties, such as is described in the Referenced Patent Documents) data, such as is described in the Referenced Patent Documents. In step 14, an impression is made in a traditional manner, which captures desired size and shape characteristics of the to-be-fabricated restoration. For example, the size of the restoration can be determined based on the space between teeth adjacent to the location of the restoration. Restoration thickness can be determined from the post structure. Such aspects of the dental impression are well known to those of skill in the art. In step 16, the impression, photograph and optical properties of the tooth are delivered to the dental laboratory or other location where the restoration is to be fabricated. Steps 10 through 16 illustrated in FIG. 1A typically are performed by the dentist or dental assistant in the dental operatory.

In accordance with preferred embodiments of the present invention, the optical properties of the tooth include color and preferably translucency, both of which preferably are determined from a front-side only measurement of the tooth. Techniques for quantifying such optical properties of tooth and other dental structures are described in the Referenced Patent Documents. The color information preferably is stored and reported as tri-stimulus coordinates or as a spectrum. The translucency preferably is reported as a coefficient of absorption (fraction). In alternative embodiments, color and translucence information are stored and/or reported separately or in a form that reflects both color characteristics and translucence characteristics. The present invention is not limited by how such characteristics are stored, reported and/or processed, etc.

In accordance with preferred embodiments of the present invention, the technician or other personnel (typically located at the dental laboratory but which may be in or near the dental operatory) fabricates a crown in accordance with the process flow illustrated in FIG. 1B. In step 20, the coping is prepared, such as described previously. From the thickness of the coping, which fits over the post and is easily measured with a caliper or similar instrument, the available thickness for the restoration may be determined, as is known to those of skill in the art. Such thickness information preferably is input into the ceramic mixing system or other instrument as will be described in greater detail hereinafter. Preferably based on such thickness information and the measured optical properties of the tooth to which the restoration is to be matched, in step 22 a look-up table or other computer implement or algorithm is used to determine a best or appropriate opaque layer material. The opaque material is applied to the coping and fired in a dental ceramic furnace (such material application and furnace heating are well known to those skilled in the art). Optionally, after step 22 the structure resulting from step 22 may be measured with a shade measuring instrument.

In step 24, the dentin material is determined based on the measured optical properties (which include optical properties of the adjacent teeth but which may also include optical properties measured after step 22) and final thickness of the tooth. Specific procedures exist for those skilled in the dental ceramic arts to determine the final thickness of the dental restoration based on physical characteristics of the coping. The final dental restoration thickness minus the coping thickness in general equals the total thickness of all ceramic layers. In certain preferred embodiments, however, the dentin material is mixed from a minimal set of dentin materials to vary the final color and translucency of the restoration. The ceramic materials to be utilized and their ratios are determined by a set of look up tables (or other computer implement or algorithm) specific to the ceramic materials being utilized by the technician (or other personnel). Such a lookup table desirably also outputs to the dental technician the specific thickness for each layer necessary to achieve the desired optical properties for the dental restoration. For example, one dental ceramics manufacturer may produce six different ceramic powders enabling variations in value, chroma and hue, while another may produce more or fewer ceramic powders dependent upon their preference and ceramics manufacturing techniques. In general, preferred embodiments of the present invention may be used with a wide variety of such ceramic materials, and in general may be used with any ceramic materials that are mixable to produce structures with predictable optical properties. Generally in all cases, however, the dental technician mixes the ceramic materials to produce a dentin layer that will result in a final restoration that closely matches the optical properties of the neighboring teeth. This is in contrast to conventional techniques, in which the technician attempts to produce a color from a set of ceramic materials in which the materials are specified and manufactured to correspond to match specific shades in a shade guide system. Thereafter, in step 24, the dentin layer may then be fired.

In step 26, the technician preferably measures the optical properties of the resulting structure, such as previously described. If the desired optical properties, in particular color and preferably translucency, are achievable with the resulting structure, the technician continues to complete the restoration. In certain preferred embodiments, data from the optical properties measurement (either in the shade measuring instrument or in a computing device coupled thereto) is used to automatically or otherwise predict whether a visually acceptable end restoration is achievable based on the current structure. This prediction is based on the instrument or other computing device having information regarding the optical properties obtainable with the available ceramic materials. With information regarding the desired end optical characteristics of the restoration, information regarding the current optical characteristics of the structure and information regarding the available ceramic materials, a lookup table or other computer implement or prediction algorithm informs the technician of the prediction. Based on the prediction, the technician is provided information from which the technician may choose to abandon the restoration and start over, or make adjustments to the current structure in order to increase the probability of being able to achieve the desired optical characteristics. For example, the technician, optionally assisted with information output from the prediction process, may adjust the thickness of the combined dentin and opaque layers (only the dentin layer's thickness can be adjusted after firing) or modify the color with a stain.

Note that much of the dental art and time in restoration preparation is at the dentin and enamel stages. Thus, it is useful for a technician to know at this step whether or not the final color can be satisfactory, rather than completing the final crown only to discover that the color is wrong. It also is important to note that, at this stage, the color of the restoration will be different from the final restoration. The color and translucency at this step, and remaining available thickness, determine whether or not the desired restoration optical characteristics can be achieved after applying the enamel layer.

In step 28, the color and translucency, and remaining available thickness, preferably are utilized to determine the enamel material or materials to be utilized in the final enamel layer. The enamel material or materials are mixed and applied to the restoration and fired in a furnace. In step 30, the optical properties of the restoration may be measured with the shade measuring instrument and analyzed. As is known in the art, certain color adjustments may be made with stains and the like. Preferably, the shade measuring instrument (or computing system coupled thereto) output information to guide the technician whether such color adjustments are desirable to bring the optical characteristics of the restoration to more closely correspond to the desired optical characteristics, and if so how to apply such stains. For example, information may be output so that the stains may be selected and applied to result in appropriate value, hue and/or chroma adjustments.

Without being bound by theory, the color of a dental ceramic is affected by the absorption of light, similar to materials such as paint. Paint relative to dental materials is more opaque. The color of paint can be varied by adding and mixing different pigments. The color of dental ceramics can be varied by adding and mixing different metal oxides. The number of pigments or metal oxides required depends upon the materials available.

It is known that the color of paint can be varied with three saturated pigments such as red, green and blue and a dilution medium which reduces color saturation. This principal is widely utilized in the color printing industry to reproduce a wide range of colors with four ‘inks’ (the saturation typically is varied by spatial dithering). More advanced printers often utilize seven inks to improve color reproduction. In all cases, however, a very broad range of colors (millions) are achieved with a limited number of pigments rather than having an ‘ink’ for each desired color.

In the present invention, a similar principal is adapted, modified and optimized for dental ceramics and dental restoration. In accordance with certain preferred embodiments, minimally, there are two or more materials (ceramic powders) that are mixed in differing ratios to produce a dental color. Various combinations of the materials affect the hue, value, saturation and translucency. Thus, by mixing different portions of the ceramic materials, dental restorations are produced for all colors and preferably translucency ranges of interest with a minimal set of dental ceramics, as is explained in greater herein.

As an added benefit of embodiments of the present invention, it should also be noted that currently available dental ceramics in general can be utilized in accordance with the present invention. While certain conventional ceramic material systems keyed to shade guides allow some mixing of materials, for example, to achieve an interpolated shade between two adjacent shade guide values, in general materials cannot be mixed to produce restorations that correspond to arbitrary measured color and translucence properties. Attaining such results conventionally is exceedingly difficult as colors resulting from mixing such ceramics are difficult for a dental technician or any human to predict. For example, mixing an A1 shade ceramic material with a C3 shade ceramic material does not produce a ‘B2’ shade, but in general it should produce a consistent but unknown color. In accordance with the present invention, by quantifying the mixing properties of any dental ceramics system (or even materials from different ceramic systems) one can reduce the number of ceramics required to cover much or all of human dental color space. Indeed, it additionally permits dental technicians to produce crowns for dental colors not covered by a shade guide system.

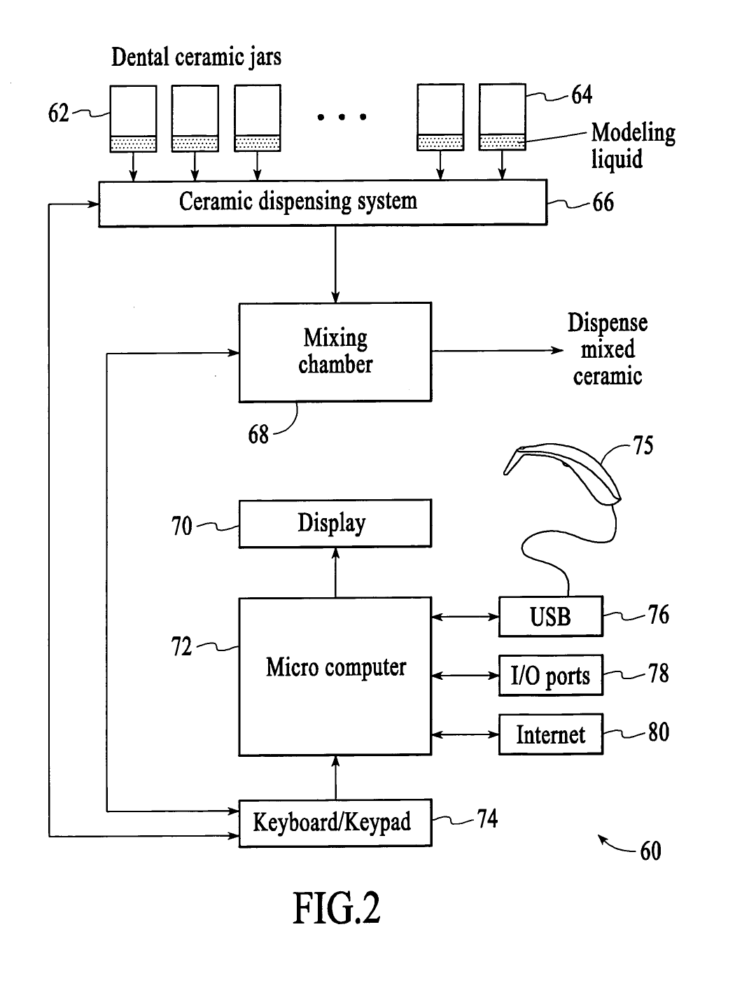

FIG. 2 is a block diagram illustrating a dental ceramics preparation system in accordance with additional preferred embodiments of the present invention. Ceramics preparation system 60 includes dental ceramic materials jars (dispensers) 62. These jars may be of conventional design, and desirably are easy to install, remove, refill and/or replace as needed to maintain an adequate supply of the various ceramic materials. The number of jars depends upon the ceramic materials chosen by the dental laboratory, but in general the number of jars is minimized in accordance with the present invention. Ceramic materials from jars 63 feed into dispensing system 66 that dispenses the ceramic materials in a wide range of computer-controlled ceramic ratios. Dispensing system 66 deposits the ceramics into mixing chamber 68, which combines the materials preferably into a smooth paste that is utilized by the dental technician. Dispensing system 66 may measure, mix and dispense the materials in their powder form or alternately adds modeling liquid (from modeling liquid reservoir 64) to the powders to produce a ceramic slurry for mixing and dispensing. The modeling liquid may facilitate transport of the ceramic materials within the dispensing system. Those of skill in the art will appreciate that a variety of conventional powder and/or slurry feeder and mixing systems may be utilized to implement dispensing system 66 and mixing chamber 68.

Ceramics preparation system 60 also has inputs for the optical properties, preferably from a spectrophotometer-based shade measuring instrument such as the Vita Easyshade system, and restoration thickness. In certain preferred embodiments, ceramics preparation system 60 includes keyboard/keypad 74 for entering, for example, color coordinates, restoration thickness information, patient identification or other identification information, and/or control information. Display 70, which may be an LCD, CRT or other suitable conventional display, preferably guides the technician through the mixing stages and/or reports status information. Ceramics preparation system 60 also preferably includes USB interface 76 and 10 ports 78, which may include any suitable serial, parallel or memory interface (e.g., memory stick, flash drivers, etc.) for electronic input. Preferably, ceramics preparation system 60 is controlled by microcomputer or microprocessor 72 (or other small computer) with memory resources and software that controls the mixing process. Internet connection 80 preferably is provided, which may be a wireless or wired LAN or other broadband connection, or alternatively a dial-up connection. The type of Internet connection is not critical. What is important in such embodiments is that the system has the ability to connect to remote computers, such as for receiving instructions, data (e.g., optical characteristics data of a tooth measured at a remote location) or other information, which may include email communications and the like. Also, as an example, USB interface 76 may be utilized to interface with shade measuring instrument 75, which in a preferred embodiment is a Vita Easyshade system. Other types of shade measuring instruments, preferably capable of measuring color, translucence and preferably other optical properties may be utilized, using USB interface 76 or any other type of electronic interface.

In operation, ceramic preparation system 60 receives via data input (e.g., keyboard/keypad 74) or electronic connection (e.g., USB interface 76, 10 ports 78 or Internet connection 80) data representing (preferably) color and translation information. In accordance with preferred embodiments, the technician enters or the system otherwise receives information regarding the available thickness for preparing the restoration. In addition, ceramic preparation system 60 also receives information regarding the optical characteristics of each of the ceramic materials provided via jars 62. This information may be provided by the ceramics manufacturer in some form (such as will be described hereinafter), but preferably is provided by way of a shade measuring instrument such as the Vita Easyshade system, which measures test or other samples produced using jars 62. What is important is that ceramic preparation system 60 stores data representing optical characteristics of layers made with the input ceramic materials, so that a lookup table or other implement, algorithm or the like can be used to generate suitable recipes for the various layers of the restoration. Based on such inputs, ceramic preparation system 60 determines the proper ratio of materials for each of the layers and dispenses them in turn to the technician. In preferred embodiments, this is a three-layer process as described previously. In alternative embodiments, this may be reduced to a two layer process, such as an opacious dentin layer followed by an enamel layer. What is important is that based on information indicative of the input materials and the target restoration optical characteristics and available thickness, ceramics preparation system 60 generates materials and information from which the restoration may be prepared. It should also be noted that, in certain embodiments, the technician may enter the desired constancy of the dispensed ceramic slurry based on personal preferences or the like.

In certain preferred embodiments, the system receives direct input from a dental optical measurement device such as the Vita Easyshade system. As the layers of the restoration are generated (typically the base ceramic core, and after each firing, such as previously described) the optical properties of the restoration at the various stages are measured with the Vita Easyshade system and input to the dispensing system. The dispensing system may then determine or predict if a final restoration having desirable optical properties is obtainable from the restoration in the current state, and either indicates that the restoration should be rejected, or recommends alterations (such as staining or thickness reduction) and/or outputs materials and information for preparing the next ceramics layer or layers accordingly. Thus, the recipe for a subsequent layer or layers may be altered or refined based on measured optical characteristics of prior layer or layers. It is also within the scope of the present invention that the restoration be fired only a single time or only two times, with one or more layers fired simultaneously.

In another alternate embodiment of the present invention, the system consists of a computer and software (ceramic preparation system). The computer and software receive similar data inputs such as described above in connection with FIG. 2, and outputs data that instructs the dental technician what ratio of ceramic materials to mix at each step and what the correct thickness for each layer should be. In such embodiments, the computer preferably also receives data from a shade measuring instrument such as the Vita Easyshade system to input optical characteristics information for the available ceramic materials, the target restoration, and also to test the progress of the restoration's optical properties at intermediate layers/steps and predicts the materials of subsequent layers. The technician mixes the materials in the ratios prescribed by weight or by volume by hand or by measuring utensils. The layer prediction proceeds such as described earlier, but the material mixing is done manually rather than by an automated mixing system. In such embodiments, the computer and software preferably are integrated into the shade measuring system, or are provided by a computer coupled to or receiving data from the shade measuring system.

In yet another embodiment of the present invention, the mixing ratios are determined by printed charts utilized by the technician. In such embodiments, the system preferably receives the same optical inputs and instructs the technician via charts that are printed by the system or by reference to pre-printed charts. Such charts preferably are constructed for different classes of dental materials.

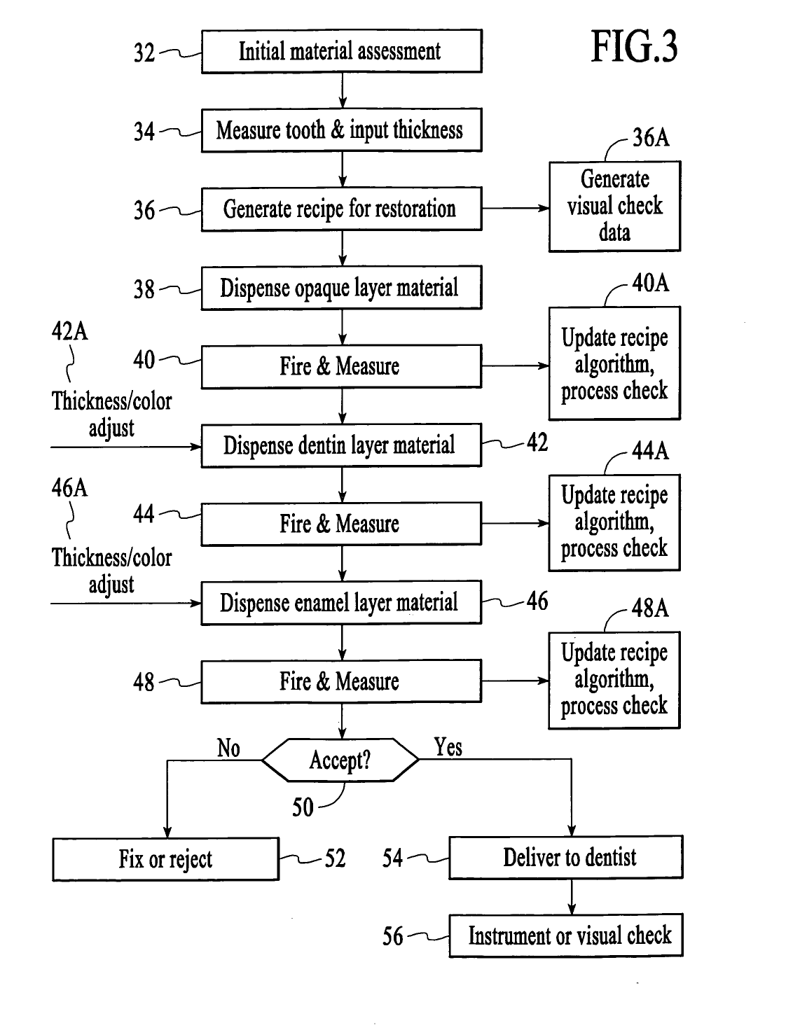

Referring now to FIG. 3, an exemplary process flow diagram illustrating additional detailed steps in accordance with certain alternative preferred embodiments of the present invention will now be described. In accordance with such alternative embodiments, the system (such as that illustrated in FIG. 2 in combination with a shade measuring instrument such as the Vita Easyshade system) is adaptive and further accommodates operational history of the overall process.

In step 32, the available ceramic materials are assessed regarding their optical properties. This preferably is performed by measuring one or more test samples of a prescribed thickness with the shade measuring instrument, with the optical characteristics data input to the system. This step could be performed by the ceramics manufacturer, with the resulting optical characteristics data electronically (such as via Internet connection or other electronic transfer) or manually (such as by keyboard entry) into the system. In preferred embodiments, the test samples are prepared using the same furnace and firing conditions that will be used to prepare restorations. In any event, what is important is that the optical characteristics of the actual ceramic materials that will be used to prepare restorations be assessed so that data resulting from the assessment may be used in the layer recipe prediction process of the present invention. These ceramic materials are then available for use in preparation of the restoration, either with a machine as illustrated in FIG. 2 or manually, such as described previously.

In step 34, an adjacent tooth may be measured with the shade measuring instrument. Optical characteristics of the tooth, preferably including color and translucence characteristics, which preferably are determined such as described in the Referenced Patent Documents. Such data preferably is obtained with a front side only assessment of the tooth. What is important is that such “target” optical characteristics data be provided to the system so that layer recipes or mixtures of materials may be provided in order to prepare the restoration. Also in step 34, thickness information such as based on the overall tooth thickness and coping thickness, etc. are input to the system, such as described elsewhere herein.

In step 36, the system preferably generates a recipe and/or materials for the restoration. This step may produce a recipe and/or materials for only the first layer of the restoration, or alternatively may provide a recipe and/or materials for all or a subset of the layers of the restoration. In preferred embodiments, the recipe and/or materials are for a single layer, and recipes and materials for subsequent layers are generated after prior layers are prepared and measured with the shade measuring instrument. Both processes are within the scope of the present invention, although the later embodiment is more directly illustrated in FIG. 3.

In step 38, a recipe and/or materials for the first layer, preferably an opaque layer, is generated or dispensed. The recipe and materials are generated based on a prediction by the system of the desired optical properties of each layer so that the final restoration has the desired, target optical properties, as has been described previously.

In step 40, the materials (typically a mixture of the available ceramic materials) is applied to the restoration, which at this stage may be a coping as previously described, and the restoration preferably is fired and measured with the shade measuring instrument. With optical characteristics of the restoration at this interim step determined with the shade measuring instrument, the system may assess the accuracy of its prediction for the subject layer. As indicated by step 40A, the system may collect and store operational data based on samples prepared using the available ceramic materials and the firing furnace, and adapt its predictions based on the collected and stored operational data. Such adaptations preferably are done with “statistical hysteresis” so that recipe/layer prediction adjustments are made based on an appropriate set of data. Dramatic or non-steady deviations from the predicted optical properties may be an indication that the equipment is in need of service, or otherwise that the process is out of specification and/or in need of calibration or maintenance. For example, the material feeding mechanism of the mixing machine and/or furnace temperature or other firing conditions may be operating incorrectly. In step 40A, preferably optical characteristics of the measured layer are used to adapt the prediction algorithm for future restorations and/or to serve as a process check for the system.

In step 42, preferably also based on the data collected at step 40, the system generates and/or dispenses a recipe and/or materials for the next layer, preferably a dentin layer. The recipe and materials are generated based on a prediction by the system of the desired optical properties of this layer or layers so that the final restoration has the desired, target optical properties, as has been described previously. It should also be noted that in conjunction with or prior to step 42, the system preferably assesses whether the target optical characteristics of the final restoration are achievable. The system may, for example, recommend thickness or color adjustments prior to preparation of subsequent layers, as illustrated with optional step 42A. As previously described, material may be removed from the restoration and/or stains or other colorants may be applied at this interim stage. The system preferably outputs recommendations for such thickness and/or color adjustments based on an assessment of whether the desired target optical characteristics are achievable with the available ceramic materials and the remaining available thickness for the subsequent layers. It should be understood that such thickness and/or color adjustment steps may be followed by another measurement with the shade measuring instrument, with the recipe and/or materials generated based on such additional measurement. It also is within the scope of the present invention that the thickness and/or color adjustment and measurement steps be performed multiple times if the system determines that such multiple iterations are more likely to result in a final restoration of the desired target optical properties.

In step 44, assuming the restoration process continues and has not been rejected after the measurement and assessment at step 40 and/or 42, the next (dentin) layer is applied, fired and measured. Similar to the operation described for step 40, in step 44 this next resulting interim stage of the restoration preferably is assessed with the shade measuring instrument, with process adaptation and/or process checks preferably performed as illustrated with step 44A (step 44A preferably is similar to step 40A and will not be further described).

Step 46 is similar to step 42, although at this step the recipe and/or materials for the preferably final layer (preferably an enamel layer) are generated. Optional step 46A is similar to optional step 42A. What is important is that a similar methodology preferably be applied at each layer so that appropriate checks and adjustments are made so that the restoration may be rejected at the earliest possible stage if an acceptable restoration is predicted to be unachievable, or thickness and/or color adjustments recommended prior to the application of subsequent layers. Steps 46 and 46A will not be further described.

In step 48, the third, preferably final, enamel layer is prepared, fired and measured with the shade measuring instrument. Step 48A is similar to steps 40A and 44A and will not be further described. At this stage the restoration is at or near the final stage. In step 50, based on the measurement at step 48, an assessment is made whether the restoration has optical properties that adequately correspond to the target optical properties. If the assessment indicates that the restoration has acceptable optical properties, the restoration is delivered to the dentist as indicated by step 54. Alternatively, if the assessment indicates that the restoration does not have acceptable optical properties, further analysis preferably is performed as illustrated by step 52. In step 52, the system may recommend that further thickness or color adjustments be made, although typically thickness adjustments are not desirable at this stage of the restoration preparation process. It is quite common, however, for technicians to make slight color adjustments at such a stage, and after such color adjustments a further measurement may indicate that the restoration is now of acceptable optical properties and may be provided to the dentist. Such adjustment and measurement steps may be repeated as required to make an acceptable restoration. The instrument or the technician, however, may determine at this stage that the restoration is not acceptable, and the restoration may be rejected.

Additionally, the present invention also contemplates all ceramic restorations, which are semi-translucent and are typically cemented to the tooth with a luting cement. As is known in the art, luting cements typically have color characteristics that contribute to the final restoration's color in vivo. The luting cement preferably is selected based on the prepared tooth optical properties (“stump color”) which is measured by the dentist with a shade measuring instrument, as described previously. In accordance with the desired target optical characteristics for the restoration, the dental technician can measure the final restoration and the system preferably outputs the most appropriate luting cement for the dentist to use when installing the final restoration. Typically, luting cement kits (such as Panavia21), are keyed to a shade guide system and have up to as many cement colors as available shades. What is important is that, in accordance with the present invention, optical properties the specification of an appropriate luting cement may be generated based on the optical properties of the available luting cements, much as appropriate ceramic materials are selected in order for the final restoration to have the desired target optical properties. The luting cement specification (materials and color, etc.) preferably are sent to the dentist electronically or they accompany the restoration when it is delivered to the dentist so that the appropriate luting cement is used to install the restoration based on the desired target optical properties for the restoration.

It will also be appreciated that the foregoing process may be applied to the exemplary three layer restoration build-up process (i.e., opaque layer, dentin layer, enamel layer, etc.), but is also applied to a four layer (or other number) restoration build-up process (i.e., opaque layer, opaque dentin layer, dentin layer, enamel layer, etc.). Regardless of the number of layers, what is important is that the materials of each layer, and its thickness, and optionally the luting cement, be predicted and/or provided such that the final restoration has the desired optical properties.

Optionally, if the restoration is delivered to the dentist, such as illustrated in step 54, the dentist may desire to visually check the restoration with a physical shade guide. In preferred embodiments, such restoration checking, whether performed by the dentist or the technician, is conducted with the shade measuring instrument. Given the familiarity of dentists with conventional shade guides, such visual checks may occur. As will be appreciated in accordance with the present invention, however, shade guide information is not intrinsic to the recipe/material mixing process, and in fact such predictions in accordance with preferred embodiments utilize more color and translucence information than is presented with conventional shade guides. Thus, the recipe and material preparation is independent of any physical shade guide, although the physical shade guide may end be using as a visual check for the restoration.

In accordance with alternative embodiments of the present invention, at step 36A the target optical characteristics are presented in the form of some suitable visual check data or information. As step 34 typically is performed by the dentist in the operatory, the physical shade guide that the dentist would use to perform the visual check of the restoration is in the operatory. In certain embodiments, the dentist measures with the instrument the various tabs of the visual check shade guide. This ensures that the measurement instrument knows the actual optical properties of the visual check shade guide. Based on this information, the instrument may also now predict which shade or shades of the visual shade guide present the closest match to the desired optical properties of the final restoration. In preferred embodiments, the data output is in the form of an explanation of how the target shade relates to one or more of the shade tabs in the visual check shade guide, as a very high percentage of the restorations will be in between multiple tabs of the visual check shade guide. What is important is that, if a visual check is going to be performed with a shade guide, the instrument presents visual check data in a manner to reduce incorrect visual assessments.

It should also be noted that additional effects may be added to the process as previously described, examples of such special effects being fluorescence, pearlesence or opalescence, etc. Such effects may be predicted by the shade measurement instrument or alternatively may be selected by technician input. Such effects would be applied typically with additional ceramic materials that generate the desired effect. The system desirably adjusts or adapts its recipe/material generation if such additional effect materials are applied. In the example of FIG. 2, additional ceramic jars 62 may be utilized for the ceramic materials providing the effects.

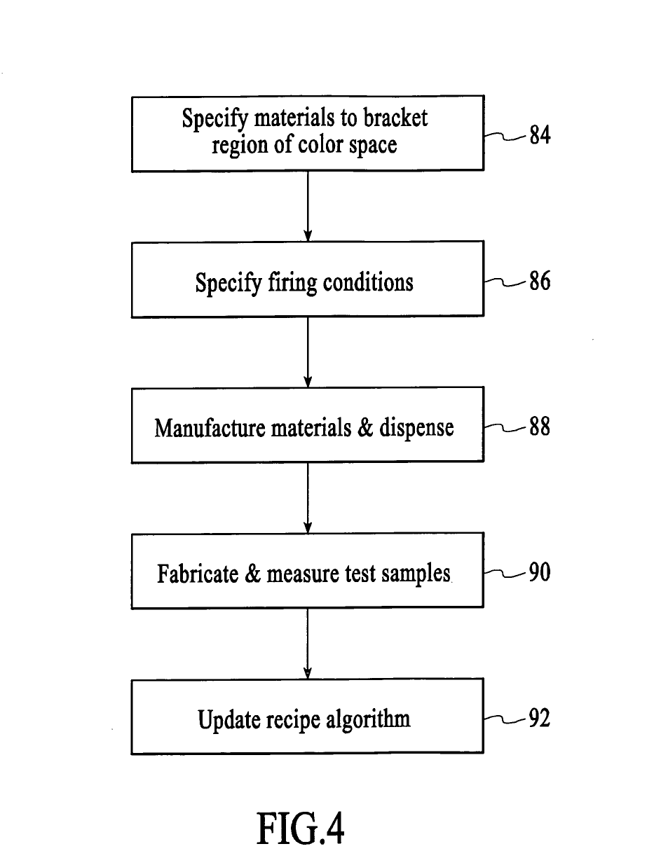

As will be appreciated from the foregoing description, the present invention provides new ways of generating and dispensing ceramic materials for dental restorations. Further aspects of the present invention will now be described in connection with FIG. 4, which is an exemplary process flow diagram illustrating methods of manufacturing and distributing ceramic materials in accordance with certain preferred embodiments of the present invention.

As previously described, current ceramics manufacturing produces ceramics with optical properties that match a shade guide system. Shade guide systems, however, tend to have a relatively large number of possible shade guide values. This results in a large number of different ceramic materials, each of which should have the same optical properties. This imposes great costs on the ceramics manufacturers, who must manage and impose strict quality control on a large number of materials. In addition, ceramics manufacturers tend to have multiple lines of ceramics, further multiplying the scope and complexity of the problem. In accordance with the present invention, ceramics materials are manufactured and dispensed in accordance with a different methodology.

As illustrated in step 84, in accordance with embodiments of the present invention a more limited number of materials are developed or specified that will “bracket” the region of color space of interest for dental restorations. For example, ceramic materials are defined (preferably two different materials) that in combination provide the value range of all human teeth of interest. These two materials preferably have little hue or chroma, and when mixed in proportions can produce a wide range of value. Two or more additional ceramic materials that provide differing hues (e.g., a yellowish hue and a reddish hue), such that mixtures of these materials determine the hue of the restoration, while the quantity of the materials determine the chroma or saturation. Thus, with as few as four ceramic materials, the value, hue and chroma of restorations for a large percentage of human teeth are obtainable. While the present invention is not limited to four materials or any particular number of materials, what is important is that the materials are selected to provide materials that in reasonable mixtures/combination “bracket” a region of color space such that restorations are obtainable for most human teeth of interest. This is hereafter referred to as the “color space bracketing material set,” which preferably consists of 4, 5 or 6 ceramic materials, but in any event fewer than 10 ceramic materials (not including special effect ceramics, as described elsewhere herein).

In conjunction with specifying the color space bracketing material set, firing conditions (e.g., time, temperature and/or other ambient conditions) for the ceramic materials are specified, as illustrated in step 86. As resulting optical properties of objects made with the ceramics are a function of the firing conditions (particularly temperature), such conditions are specified in conjunction with the specification of the color space bracketing material set.

In step 88, materials for the color space bracketing material set are manufactured in volume, preferably in batches. It should be noted that, in accordance with the present invention, quality control requirements for the color space bracketing material set is substantially reduced as compared to conventional ceramics. With conventional ceramics, batch to batch variations of the optical properties of the ceramic materials is a source of incorrect shades in restorations (i.e., the recipes tied to shade guides are premised on each and every batch of material keyed to the shade guides having the same or essentially the same optical properties). In accordance with the present invention, however, the materials are not keyed to shade guides but instead are specified to bracket the region of interest of color space. In fact, the optical properties of the materials may correspond to few if any shades of interest. What is important is that the materials in combination be capable of covering the desired region of color space, with the instrument/system predicting the recipe of materials to produce a restoration of desired optical properties. Ideally, variations within a batch of materials are kept to a minimum (although adaptive embodiments of the present invention will accommodate reasonable intra-batch variations), while batch to batch variations generally will be accommodated with the prediction algorithm of the instrument/system.

In step 90, test samples of each of the various materials of the color space bracketing material set, and preferably mixtures of defined combinations (e.g., 50-50 mixtures, 30-40-30 mixtures, etc.), and preferably of predefined thicknesses, are prepared and fired in accordance with the specified firing conditions, and measured with the shade measuring instrument. The test samples preferably are chosen to confirm that the color space bracketing material set in fact adequately brackets the region of color space to capture most human teeth of interest, and also to provide data for the shade prediction algorithm (as has been described previously herein). In step 92, the shade prediction algorithm is updated based on the measured optical characteristics of the actual ceramic materials in the color space bracketing material set.

It should be noted that, at the location where the restoration is to be fabricated, steps 90 and 92 typically would be performed upon receipt of each new batch of ceramic materials. With the shade prediction algorithm based on measured optical properties of the actual materials that will be used to fabricate the restoration, batch to batch variations will be accommodated with the shade prediction algorithm. The ceramic manufacturer can manufacture and distribute a reduced number of ceramics with reduced concern over batch to batch variations, and the dental laboratories need to stock far fewer bottles of ceramics. In accordance with the present invention, improved restorations at lower costs are obtainable.

Alternative embodiments of the present will now be described. As will be appreciated by those of skill in the art, such embodiments may work in conjunction with the recipe/ceramic material mixing embodiments previously described, or may be utilized independently. In accordance with such alternative embodiments, the physical formation of a dental impression in the dental operatory by the dentist, and the delivery of the dental impression to the laboratory or other location where the restoration is to be fabricated, are eliminated. Use of such “virtual impression” formations may be used in conjunction with automated recipe and/or ceramic material mixing as previously described or used with conventional shade guide-based ceramic recipe formulations. Both are within the scope of the present invention.

As previously described, a typical step in the process of producing a dental restoration is the creation of an impression of the patient's teeth or dental arch. As described earlier, the physical impression captures positional and size information for the location of the tooth to be replaced with the restoration, as well as adjacent teeth. The impression typically is the way in which such physical information is conveyed to the laboratory for producing the restoration. As the laboratory for producing the restoration is typically located away from the dental operatory, the physical impression typically must be delivered by mail or courier or other hand-carry type of delivery service. This process typically results in a second visit by the patient after the crown has been produced by the laboratory and returned to the dentist. The majority of restorations currently are produced using this type of procedure.

In order to avoid such a second visit type process, the use of 3D imaging systems and CAD/CAM milling systems have been developed. One of the leaders in this field is Sirona Dental Systems GmbH, of Bensheim, Germany. With such systems, one or more cameras or other imaging elements or lasers capture three-dimensional position or image data of the visible surfaces of the tooth or teeth, which is compiled into a data record. The data record, which in essences consists of a 3-D electronic representation of the tooth or teeth, and captures physical characteristics of the examined structures. It is in effect a “virtual representation” of the dental structures in an electronic form that can be processed and used as inputs to a CAD/CAM grinding machine, which mills a restoration from a specially formed ceramic blank. Such methods, machines and structures are known in the art and described in, for example, U.S. Pat. Nos. 7,010,150, 6,485,305, 6,394,880, 6,319,006, 6,614,538, 6,454,629, 6,702,649, 6,885,464, and 6,953,383, which are hereby incorporated by reference. Based on such disclosures, it is appreciated by those of skill in the art that the ability to produce 3-D data models of dental structures may be produced, and these data models may be used to mill ceramic restorations.

Such CAD/CAM techniques provide significant advantages in certain respects, and certain disadvantages in other respects. The advantages include the ability to produce a restoration in or near the dental operatory and produce a restoration in a single patient visit. The disadvantages include cost (as such machines currently are quite expensive for many dentists), and the fact that the restoration is formed from a single block of material, while human teeth actually are formed from various layers. Thus, in terms of producing restorations that more closely resemble natural human teeth, which have significant optical complexity, the traditional approach of using multiple layers of ceramic materials of optimized color, translucency and thickness often results in more life-like restorations.

In accordance with alternative embodiments of the present invention, a “virtual impression” is created in the dental operatory using 3-D imaging (such as in the patents referenced above), or via other suitable electronic implement (e.g., lasers). This process produces an electronic or virtual impression of the teeth of interest or dental arch, but a physical impression is not created. The virtual impression data, which preferably may be viewed with a computer for confirmation purposes by the dentist, is electronically processed and transmitted to the dental laboratory. In preferred embodiments, the transmission of the virtual impression data is accompanied by color and translucence data output from a shade measuring instrument such as the Vita Easyshade system as previously described, and optionally may be accompanied by an electronic transmission of a photographic image of the tooth, teeth or arch, such as is described in the Referenced Patent Documents. Typically, the laboratory is at a location remote from the dental operatory, and in certain preferred embodiments the laboratory is located quite far from the dental operatory (e.g., the dental operatory could be one that services dental patients in suburban Chicago, while the location where the restoration is fabricated is in Kansas or at a geographically remote or transnational location such as China.). What is important is that all information to fabricate the restoration is transmitted electronically and the dental operatory and the laboratory/restoration manufacturing facility can be located in different cities, states, countries and regions of the world.

At the laboratory, a CAD/CAM system such as described previously receives, and to the extent required, processes the virtual impression data and produces via a CAD/CAM milling or cutting machine or tool, or other numerically controlled machine that selectively removes and/or adds material, to form a physical impression. Note that, unlike CAD/CAM systems that mill the actual restoration, such as described in the patents referenced above, the CAD/CAM system for producing the physical impression can operate more quickly and be of more efficient construction and operation as it may work with much softer materials, such as plastic or plastic-based materials, rigid foam or foam-like material, wax or wax-like materials. For example, the CAD/CAM system may be a system that uses a cutting tool, which may be heated and/or lubricated, to cut or carve the physical impression from a block or plastic, wax, or plastic-based or wax-based material. As compared to automatically milling the final restoration from a hard ceramic block as in the CAD/CAM systems of the patents referenced above, and as will be appreciated by those of skill in the art, forming the physical impression from a much softer and easier to cut material greatly simplifies the specifications and construction of the CAD/CAM system utilized in accordance with this embodiment of the present invention. It also should be noted that laser-based, or other, selective additive systems, such as those using epoxy resins or the like, are also within the scope of the present invention. Any suitable, numerically-controlled machine, additive and/or removal based, may be used to generate the physical impression in accordance with this embodiment.

After formation of the physical impression at the laboratory, and preferably after receipt of color and translucence data also electronically transmitted from the operatory, and optionally with the use of a photographic or other camera-generated image of the tooth, teeth or dental arch, the laboratory technician prepares the restoration. In accordance with this embodiment of the present invention, the restoration may be prepared using conventional, shade guide keyed ceramic materials, but more preferably utilizes either a ceramic recipe or mixture of ceramic materials generated in accordance with previously described embodiments of the present invention. Still more preferably, the ceramic materials are manufactured at a location remote from the operatory and also remote from the laboratory, and preferably in accordance with the color space bracketing material set of ceramics as in previously described embodiments. This restoration preferably is made from a plurality of layers such as previously described, such that the restoration more closely resembles natural tooth and is an acceptable visual match for the tooth or teeth of the original patient. Reference is made by the laboratory to the color and preferably translucence data of adjacent teeth generated at the operatory, and optionally the preferably digital camera image also transmitted from the operatory.

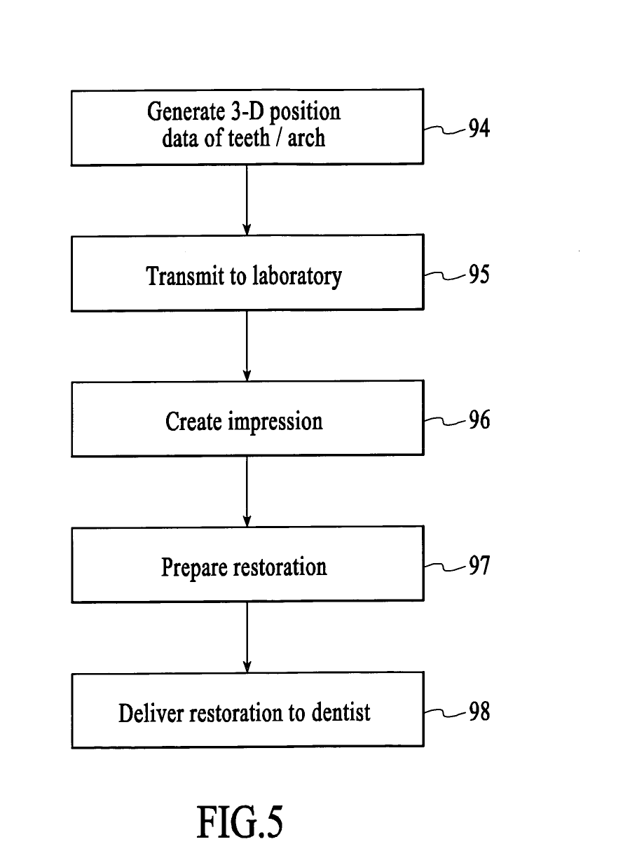

Referring now to FIG. 5, an exemplary flow diagram illustrating a process in accordance with such embodiments of the present invention will now be described.

In step 94, the 3-D position data of the patient's mouth (teeth or upper and/or lower arch, etc.) are electronically generated in the operatory, such as previously described. The data is processed as necessary to prepare the virtual impression data file that is to be subsequently transmitted to the laboratory. It should be noted that conventional tooth preparation steps such as previously described and as are known in the art are performed prior to step 94. This allows the virtual impression data file to capture data, for example, representing the size and thickness of the post or post-like structure to which the restoration will be secured, as well as the overall desired size and shape of the restoration.

In step 95, the virtual impression data file is electronically transmitted, such as by email, FTP transfer or the like, to the laboratory or other facility where the restoration will be fabricated. Any suitable type of electronic transmission may be utilized, and as previously described the geographic location of the laboratory is independent of the location of the operatory. As will be appreciated, a large plurality of geographically-distributed operatories may transmit such virtual impression data files to one or more, but far fewer, laboratory-type facilities that are located in places where large-scale restoration manufacturing operations may be desirably conducted. Also prior to or in conjunction with step 95, color and translucence data preferably generated with a shade measuring instrument such as the Vita Easyshade system of teeth adjacent to the location of the restoration, and optionally a digital camera generated image of such teeth or dental arch or arches, are also electronically transmitted to the laboratory.

In step 96, at the laboratory a physical impression is created with a CAD/CAM system, such as previously described. In step 97, the restoration is prepared, either by a conventional shade guide-keyed ceramic process, but more preferably by a process described above with reference to other embodiments of the present invention. Preferably, the restoration is formed with a multiple layer process with each layer consisting of a mixture of ceramic materials, such that the collection of constituent layers and other materials (e.g., luting cement, post structure, etc.) result in a restoration that closely resembles a natural tooth with optical properties that match other teeth (or a tooth) of the patient. The restoration process preferably utilizes color and translucency information generated by a shade measuring instrument in the dental operatory and optionally with a camera generated image, such as described above and in the Referenced Patent Documents. The laboratory also preferably uses a shade measuring instrument in the laboratory to check the visual acceptance of the produced restoration, and makes adjustments and/or appropriate recommendations for luting cement and the like, if the restoration has been determined to be of acceptable optical properties.

In step 98, the restoration is delivered back to the operatory/dentist for installation in the mouth of the patient. Such delivery may be commercial courier service with electronic tracking of the shipment, with details regarding the shipment preferably tied via software to dental practice management software of the dentist. This enables the dentist to more optimally schedule and/or confirm a subsequent visit by the patient so that the restoration may be installed.

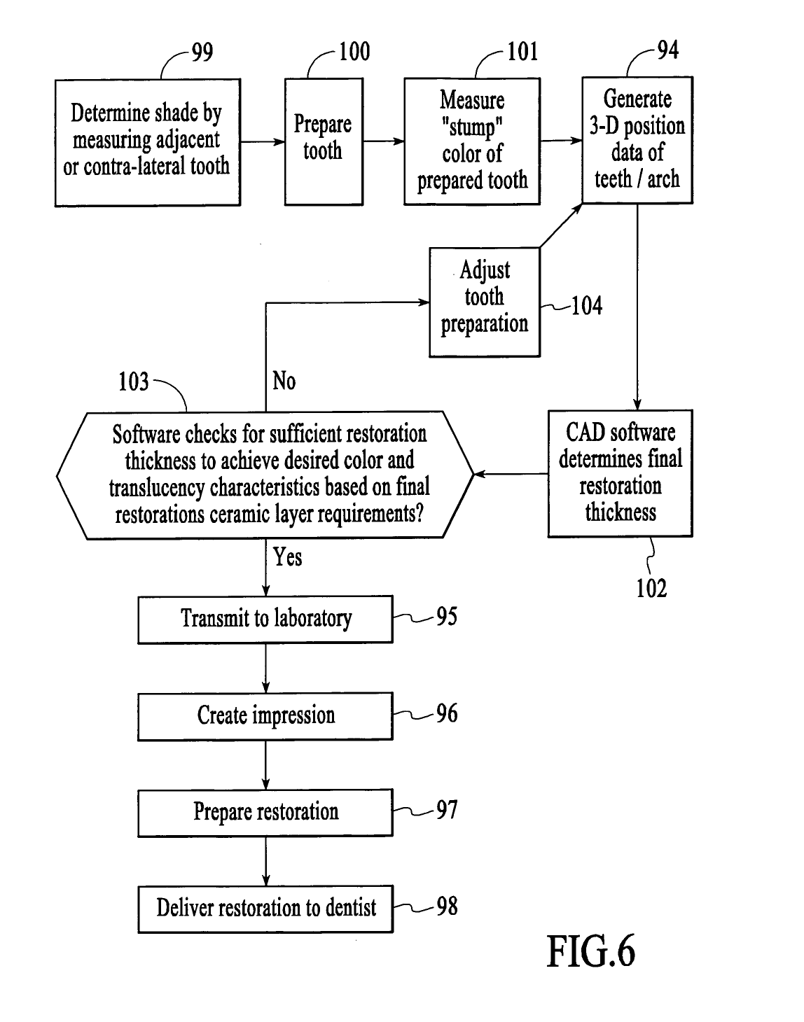

Referring now to FIG. 6, is an exemplary process flow diagram illustrating methods of producing restorations including an electronic assessment of the dentist's tooth preparation will now be described. Steps 94, 95, 96, 97 and 98 of FIG. 6 preferably are similar to like-numbered steps previously described in connection with FIG. 5 and thus will not be further described. As illustrated in FIG. 6, however, such embodiments utilize a 3-D positional data file to assess the tooth preparation process.

In step 99, a tooth or teeth adjacent to the tooth to which the restoration is to be applied is measured with a shade measuring instrument, such as previously described. In step 100, the tooth to be restored is prepared by the dentist. As previously described, this typically results in a post or post-like (or stump-like) structure to which the restoration is installed. In step 101, optionally the “stump” color of the prepared tooth is measured with the shade measuring instrument. This step preferably is performed for all-ceramic restorations, in which the stump color can affect the final optical properties of the restoration as installed in the patient's mouth (this step preferably can be omitted for PFM-type restorations, as the stump color typically has no affect on the optical properties of the installed restoration).

In step 94, 3-D positional or image data of the teeth/arch are prepared, which includes the prepared tooth. As previously described, restoration thickness is an important parameter in accordance with preferred embodiments of the present invention, and available restoration thickness is a function of the size, thickness, shape, etc., of the prepared tooth. In such alternative embodiments, in step 102 CAD software analyzes the 3-D positional data to determine the final restoration thickness (or in other words the available thickness for the restoration in order for it to properly match the other teeth of the patient). In step 103, a software check is performed to determine if there is sufficient restoration thickness in order to achieve the desired color and preferably translucency characteristics in the final restoration. As previously described in connection with other embodiments of the present invention, based on ceramic materials available for the restoration and target optical properties, the lookup table or other computer implement or algorithm can predict optical properties of layers of the restoration given an available restoration thickness and can thus determine whether an acceptable restoration can be achieved. What is important in accordance with this embodiment is that the software assesses whether the prepared tooth provides sufficient thickness (or other physical or optical characteristics) so that an acceptable restoration may be produced. As a common example, if the prepared tooth results in an available restoration thickness that is too small, as illustrated in step 104 the dentist may perform additional tooth preparation (e.g., remove material from the prepared tooth to increase the available thickness for the restoration). Steps 94, 102, 103 and 104 may be repeated as necessary until it is predicted or determined that the tooth preparation is sufficient in order for a restoration of desirable optical properties to be obtained. If this is determined at step 103, then steps 95, 96, 97 and 98 may proceed as previously explained.

In such embodiments, a 3-D positional data file is processed so that an assessment may be made of the prepared tooth, so that further tooth preparation steps may be performed if needed.

For those skilled in the dental arts, the preceding disclosure will apply to the dispensing and application of other dental materials for direct and indirect dental restorations, such as dental composites and dental acrylics.

Although the invention has been described in conjunction with specific preferred and other embodiments, it is evident that many substitutions, alternatives and variations will be apparent to those skilled in the art in light of the foregoing description. Accordingly, the invention is intended to embrace all of the alternatives and variations that fall within the spirit and scope of the appended claims. For example, it should be understood that, in accordance with the various alternative embodiments described herein, various systems, and uses and methods based on such systems, may be obtained. The various refinements and alternative and additional features also described may be combined to provide additional advantageous combinations and the like in accordance with the present invention. Also as will be understood by those skilled in the art based on the foregoing description, various aspects of the preferred embodiments may be used in various subcombinations to achieve at least certain of the benefits and attributes described herein, and such subcombinations also are within the scope of the present invention. All such refinements, enhancements and further uses of the present invention are within the scope of the present invention.

What is claimed is:

1. A method for producing a dental restoration comprising the steps of:
determining optical properties of a set of available materials from which the restoration will be produced, wherein the optical properties are determined by fabricated layers made from the each of the materials of the set of available materials by measurement with a shade measuring instrument;
measuring optical properties of a tooth adjacent to a tooth for which the restoration is being produced;
generating a recipe of specific materials from the set of available materials for each of a plurality of layers of the restoration, wherein a thickness is specified for each of the layers of the restoration;
producing the restoration based on the recipe.

2. A method for producing a dental restoration comprising the steps of:
determining optical properties of a set of available materials from which the restoration will be produced, wherein the optical properties are determined by fabricated layers made from the each of the materials of the set of available materials by measurement with a shade measuring instrument;
measuring optical properties of a tooth adjacent to a tooth for which the restoration is being produced;
automatically generating a mixture of specific materials from the set of available materials for each of a plurality of layers of the restoration, wherein a thickness is specified for each of the layers of the restoration;
producing the restoration based on the recipe.

3. A method for manufacturing and distributing ceramic materials for dental restorations comprising the steps of:
determined a reduced color space bracketing set of ceramic materials, wherein the reduced color space bracketing set of ceramic materials comprise a reduced set of ceramic materials from which dental restorations in a region of color space applicable to human teeth may be fabricated;
manufacturing bulk quantities of each of the materials in the reduced color space bracketing set of materials;
manufacturing layers based on each of the materials in the reduced color space bracketing set of ceramic materials;
measuring optical properties of the manufactured layers with a shade measuring instrument, wherein the shade measuring instrument measures optical properties including color and translucence properties; and
distributing the reduced color space bracketing set of materials to a plurality of dental restoration fabrication locations;
wherein, based on a measurement of color and translucence properties of a tooth adjacent to a tooth to which a dental restoration is to be applied, a recipe and/or mixture of materials from the reduced color space bracketing set of materials is generated for fabrication of the dental restoration.

4. A method for producing a dental restoration at a location remote from a dental operatory comprising the steps of:
determining optical properties of a tooth adjacent to a tooth to which the dental restoration is to be applied;
generating a virtual impression data file in the dental operatory with a 3-D position data generating device;
electronically transmitting the virtual impression data file to a restoration fabrication location remote from the dental operatory;
using a CAD/CAM system to generate a physical impression at the restoration fabrication location based on the virtual impression data file; and
fabricating the dental restoration at the restoration fabrication location based on the physical impression, wherein a multiple layer ceramic restoration is produced.
